(19) United States
(12) Patent Application Publication
(10) Pub. No.: US 2021/0389654 A1
(43) Pub. Date: Dec. 16, 2021

(54) PROJECTION MODULE, IMAGING DEVICE, AND ELECTRONIC DEVICE

(71) Applicant: JIANGXI OUMAISI MICROELECTRONICS CO., LTD., Nanchang (CN)

(72) Inventors: Horatio LEE, Nanchang (CN); Martin CHEN, Nanchang (CN); Joseph LIN, Nanchang (CN); George CHOU, Nanchang (CN); Brian CHAN, Nanchang (CN)

(73) Assignee: JIANGXI OUMAISI MICROELECTRONICS CO., LTD., Nanchang (CN)

(21) Appl. No.: 17/288,480

(22) PCT Filed: Aug. 23, 2019
(86) PCT No.: PCT/CN2019/102158

§ 371 Date: Apr. 23, 2021

(30) Foreign Application Priority Data
Oct. 29, 2018 (CN) 201811268648.1

(51) Int. Cl. G03B 21/20; G03B 21/14; G03B 17/48; G02B 13/16; G01B 11/25

(52) U.S. Cl. CPC G03B 21/2033; G03B 21/142; G01B 11/2513; G03B 21/145; G02B 13/16; G03B 17/48

(57) ABSTRACT

A projection module (10), an imaging device (100), and an electronic device (1000). The projection module (10) comprises a light source (12), a mask (14) provided above the light source (12), and a projection lens (16) provided above the mask (14). The light source (12) comprises a first center (X). The mask (14) comprises a second center (Y). The second center (Y) and the first center (X) are aligned with the axial direction of the projection module (10). The optical axis (A1) of the projection lens (16) is provided at an offset to the first center (X) and the second center (Y).

### CROSS REFERENCE TO RELATED APPLICATION

The present application claims priority and rights to the patent application No. 201811268648.1, filed on Oct. 29, 2018, the content of which is herein incorporated by reference in its entirety.

### TECHNICAL FIELD

The present disclosure relates to the field of image acquisition technology, and in particular to a projection module, an imaging device and an electronic device.

### BACKGROUND

In the related art, an imaging device for acquiring three-dimensional contour information of an object includes a projection module and a receiving module. The imaging device can project specific light information to the object through structured light technology, an image sensor of the receiving module receives a light beam reflected by the object, and calculates the three-dimensional contour information of the object according to the change of the light information. Since the projected image must cover a range of a field of view of a receiving end, a field of view of the projection module needs to be larger than a field of view of the receiving module. When a distance between the object to be measured and the imaging device is too close, the received image may be incomplete or too edged, resulting in poor imaging quality. In order to make the field of view of the projection module larger and to ensure the imaging quality, an area of a laser light source and an area of a mask of the projection module are usually designed to be larger, which is not conducive to miniaturization and cost reduction of the imaging device.

### SUMMARY

The embodiments of the present disclosure provide a projection module, an imaging device, and an electronic device.

A projection module of an embodiment of the present disclosure includes a light source, a mask disposed above the light source, and a projection lens disposed above the mask. The light source includes a first center. The mask includes a second center, and the second center and the first center are aligned along an axial direction of the projection module, and an optical axis of the projection lens is offset from the first center and the second center.

In the projection module of the embodiments of the present disclosure, the center of the light source and the center of the mask are offset from the optical axis of the projection lens, so that an optical axis of the projection module and an optical axis of the receiving module intersect at a certain distance. At this time, the projected image received at the intersection is the largest and the image quality thereof is better. In this case, the field of view of the projection module can be reduced, and the area of the light source and the area of the mask can be designed to be relatively small, which is conducive to miniaturization and cost reduction of the imaging device.

In some embodiments, an offset distance between the first center and the optical axis of the projection lens ranges from 0.110 mm to 0.140 mm. In this way, the optical axis of the projection module and the optical axis of the receiving module intersect at a certain distance.

In some embodiments, the projection module includes a diffuser, and the diffuser is located between the light source and the mask. In this way, the diffuser can diffuse the light beam emitted by the light source and make the light beam distributed uniformly in the projection module.

In some embodiments, the diffuser and the light source are spaced apart, and the diffuser and the mask are spaced apart. In this way, the diffuser can be disposed as an independent element between the light source and the mask, and can diffuse the light beam emitted by the light source and make the light beam distributed uniformly in the projection module.

In some embodiments, the light source is configured to emit a light beam, the diffuser is configured to diffuse the light beam emitted by the light source to form a uniform light beam, and the mask is configured to project the uniform light beam emitted from the diffuser to form a structured light beam, and the projection lens is configured to project the structured light beam. In this way, the light beam emitted by the light source can be diffused by the diffuser to form a uniform light beam, so that the structured light beam formed by the mask has a better effect.

In some embodiments, the mask includes a light-transmitting region and a light-shielding region, the light-transmitting region is formed with a structured pattern, and the structured pattern is configured to form the structured light beam. In this way, the light beam projected through the mask can form a structured light beam corresponding to the structured pattern, that is, the mask can project the light beam to form the structured light beam; the projection lens can improve the effect of the projection of the structured light beam and achieve corresponding imaging quality.

In some embodiments, the light source includes a vertical cavity surface emitting laser array, and the vertical cavity surface emitting laser array includes a plurality of vertical cavity surface emitting lasers distributed in an array. In this way, using the vertical cavity surface emitting laser array as the light source can meet the requirement for the miniature size of the light source, and the array distribution formed by the plurality of vertical cavity surface emitting lasers can ensure the continuity of the projection of the structured light beam.

In some embodiments, the projection module includes an actuator, the actuator is configured to adjust an offset distance between the first center and the optical axis of the projection lens and an offset distance between the second center and the optical axis of the projection lens, and the offset distance between the first center and the optical axis of the projection lens is the same as the offset distance between the second center and the optical axis of the projection lens. In this way, the actuator can dynamically adjust the offset distance between the first center and the optical axis of the projection lens and the offset distance between the second center and the optical axis of the projection lens so that the projected image received by the receiving module has a better quality.

An imaging device of an embodiment of the present disclosure includes a projection module and a receiving module, the projection module is configured to project a light beam to an object to be measured, and the receiving module is configured to receive and image the light beam reflected by the object to be measured and projected by the projection module;

the projection module includes a light source, a mask disposed above the light source, and a projection lens disposed above the mask, the light source includes a first center, the mask includes a second center, and the second center and the first center are aligned along an axial direction of the projection module, and an optical axis of the projection lens is offset from the first center and the second center.

In the imaging device of the embodiments of the present disclosure, the center of the light source and the center of the mask of the projection module are offset from the optical axis of the projection lens, so that an optical axis of the projection module and an optical axis of the receiving module intersect at a certain distance. At this time, the projected image received at the intersection is the largest and the image quality thereof is better. In this case, the field of view of the projection module can be reduced, and the area of the light source and the area of the mask can be designed to be relatively small, which is conducive to miniaturization and cost reduction of the imaging device.

In some embodiments, an offset distance between the first center and the optical axis of the projection lens ranges from 0.110 mm to 0.140 mm. In this way, the optical axis of the projection module and the optical axis of the receiving module intersect at a certain distance.

In some embodiments, the projection module includes a diffuser, and the diffuser is located between the light source and the mask. In this way, the diffuser can diffuse the light beam emitted by the light source and make the light beam distributed uniformly in the projection module.

In some embodiments, the diffuser and the light source are spaced apart, and the diffuser and the mask are spaced apart. In this way, the diffuser can be disposed as an independent element between the light source and the mask, and can diffuse the light beam emitted by the light source and make the light beam distributed uniformly in the projection module.

In some embodiments, the light source is configured to emit a light beam, the diffuser is configured to diffuse the light beam emitted by the light source to form a uniform light beam, and the mask is configured to project the uniform light beam emitted from the diffuser to form a structured light beam, and the projection lens is configured to project the structured light beam. In this way, the light beam emitted by the light source can be diffused by the diffuser to form a uniform light beam, so that the structured light beam formed by the mask has a better effect.

In some embodiments, the mask includes a light-transmitting region and a light-shielding region, the light-transmitting region is formed with a structured pattern, and the structured pattern is configured to form the structured light beam. In this way, the light beam projected through the mask can form a structured light beam corresponding to the structured pattern, that is, the mask can project the light beam to form the structured light beam; the projection lens can improve the effect of the projection of the structured light beam and achieve corresponding imaging quality.

In some embodiments, the light source includes a vertical cavity surface emitting laser array, and the vertical cavity surface emitting laser array includes a plurality of vertical cavity surface emitting lasers distributed in an array. In this way, using the vertical cavity surface emitting laser array as the light source can meet the requirement for the miniature size of the light source, and the array distribution formed by the plurality of vertical cavity surface emitting lasers can ensure the continuity of the projection of the structured light beam.

In some embodiments, the projection module includes an actuator, the actuator is configured to adjust an offset distance between the first center and the optical axis of the projection lens and an offset distance between the second center and the optical axis of the projection lens, and the offset distance between the first center and the optical axis of the projection lens is the same as the offset distance between the second center and the optical axis of the projection lens. In this way, the actuator can dynamically adjust the offset distance between the first center and the optical axis of the projection lens and the offset distance between the second center and the optical axis of the projection lens so that the projected image received by the receiving module has a better quality.

In some embodiments, the receiving module includes an imaging lens and an image sensor, the image sensor is located on an image side of the imaging lens, and the imaging lens is configured to converge an incident light to the image sensor. In this way, it is advantageous for the receiving module to receive the structured light beam reflected after being projected onto the object by the projection module.

In some embodiments, the imaging device includes a processor connected to the image sensor and the actuator, and the processor is configured to analyze a line width, uniformity, and a distortion of an image formed by the image sensor to determine an imaging quality of the imaging device. In this way, when the image quality is poor, the processor sends a driving signal to the actuator to make the actuator drive the light source and the mask to move, so that the offset distance between the first center and the optical axis of the projection lens and the offset distance between the second center and the optical axis of the projection lens are maintained at optimal values, thereby improving the quality of the next-time imaging of the imaging device.

In some embodiments, the receiving module and the projection module are arranged side by side. In this way, it is advantageous for the projection module to project the structured light beam and the receiving module to receive the light beam reflected by the object.

The electronic device of the embodiments of the present disclosure includes a housing and the imaging device of any of the above embodiments, and the imaging device is mounted in the housing.

In the electronic device of the embodiments of the present disclosure, the center of the light source and the center of the mask of the projection module are offset from the optical axis of the projection lens, so that an optical axis of the projection module and an optical axis of the receiving module intersect at a certain distance. At this time, the projected image received at the intersection is the largest and the image quality thereof is better. In this case, the field of view of the projection module can be reduced, and the area of the light source and the area of the mask can be designed to be relatively small, which is conducive to miniaturization and cost reduction of the imaging device.

The additional aspects and advantages of the present disclosure will be partly given in the following descriptions, and will partly become obvious from the following descriptions, or be understood through the practice of the present disclosure.

### BRIEF DESCRIPTION OF THE DRAWINGS

The above and/or additional aspects and advantages of the present disclosure will become obvious and easy to be understood from the description of the embodiments with reference to the following accompanying drawings, in which:

FIG. 1 is a schematic view of an imaging device in the prior art.

FIG. 2 is a schematic view of a projection module according to an embodiment of the present disclosure.

FIG. 3 is a schematic view of an imaging device according to an embodiment of the present disclosure.

FIG. 4 is a schematic view of a mask according to an embodiment of the present disclosure.

FIG. 5 is a schematic view of structured light beam projected by a projection module according to an embodiment of the present disclosure.

FIG. 6 is a schematic view of an electronic device according to an embodiment of the present disclosure.

### REFERENCE NUMERALS OF MAIN ELEMENTS

projection module 10, light source 12, vertical cavity surface emitting laser 122, mask 14, light-transmitting region 142, light-shielding region 144, projection lens 16, diffuser 18, actuator 11;

imaging device 100, receiving module 20, imaging lens 22, image sensor 24, filter 26, processor 30;

electronic device 1000, housing 200.

### DETAILED DESCRIPTION

The embodiments of the present disclosure are described in detail below. Examples of the embodiments are shown in the accompanying drawings, where the same or similar reference numerals represent the same or similar elements or elements with the same or similar functions. The embodiments described below with reference to the accompanying drawings are exemplary, and are merely used to explain the present disclosure, but should not be construed as limiting the present disclosure.

In the description of the present disclosure, the meaning of “plurality” is two or more than two, unless specifically defined otherwise.

The following disclosure provides many different embodiments or examples for implementing different structures of the present disclosure. In order to simplify the disclosure of the present disclosure, the components and settings of specific examples are described below. Of course, they are only examples and are not intended to limit the present disclosure. In addition, the present disclosure may repeat reference numerals and/or reference letters in different examples, and this repetition is for the purpose of simplification and clarity, and does not indicate the relationship between the various embodiments and/or settings discussed. In addition, the present disclosure provides examples of various specific processes and materials, but those of ordinary skill in the art can be aware of applications of other processes and/or uses of other materials.

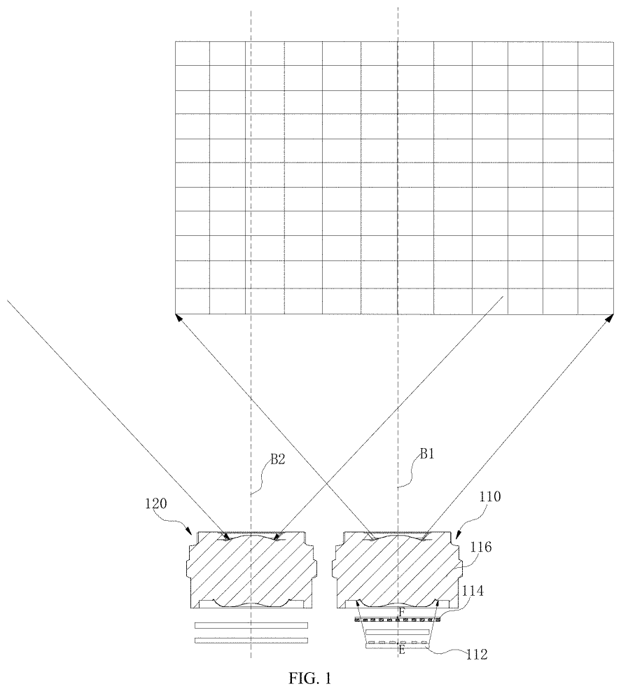

Referring to FIG. 1, in a conventional imaging device, an optical axis B1 of a projection module 110 is parallel to an optical axis B2 of a receiving module 120. That is to say, in the projection module 110, a center E of a light source 112 and a center F of a mask 114 are aligned with an optical axis of a projection lens 116. However, since an image projected by the projection module 110 must cover a range of a field of view of the receiving module 120, a field of view of the projection module 110 needs to be larger than the field of view of the receiving module 120 so that the image projected by the projection module 110 can cover the field of view of the receiving module 120. When a distance between an object to be measured and the imaging device is too close, the image (structured light beam) projected by the projection module 110 is offset from the field of view of the receiving module 120, so that the received image is incomplete or too edged image is received, resulting in poor image quality (optical modulation transfer function (MTF), distortion).

In order to make the field of view of the projection module 110 larger and to ensure the image quality, an area of the light source 112 and an area of the mask 114 of the projection module 110 are usually designed to be larger. However, this is not conducive to miniaturization and cost reduction of the imaging device.

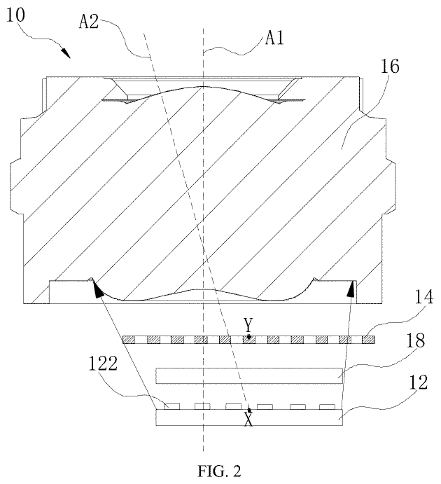

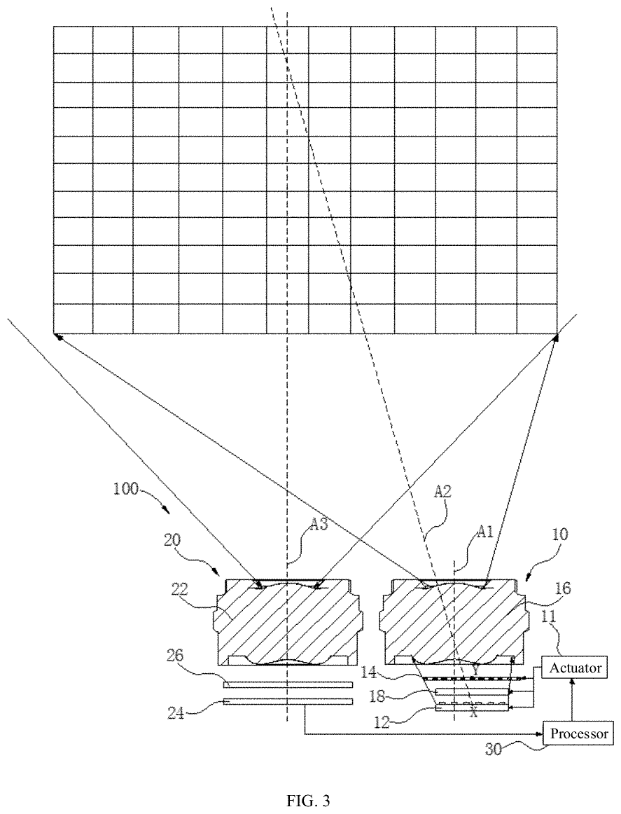

Therefore, an embodiment of the present disclosure proposes a new projection module 10. Referring to FIGS. 2 and 3, the projection module 10 according to the embodiment of the present disclosure is applied to an imaging device 100 according to an embodiment of the present disclosure. The imaging device 100 includes a projection module 10 and a receiving module 20. The projection module 10 includes a light source 12, a mask 14 disposed above the light source 12, and a projection lens 16 disposed above the mask 14. The light source 12 includes a first center X. The mask 14 includes a second center Y, and the second center Y and the first center X are aligned along an axial direction of the projection module 10 (a direction parallel to an optical axis A1 of the projection lens 16). The optical axis A1 of the projection lens 16 is offset from the first center X and the second center Y. The “above” refers to a corresponding exit direction when the light source 12 emits upward as shown in the figure.

In the projection module 10 of the embodiments of the present disclosure, the center X of the light source 12 and the center Y of the mask 14 are offset from the optical axis A1 of the projection lens 16, so that an optical axis A2 of the projection module 10 and an optical axis A3 of the receiving module 20 intersect at a certain distance (for example, 50 cm). At this time, on the one hand, the projected image (structured light beam) received at the intersection is the largest and the image quality thereof is better; on the other hand, the field of view projected within a short-distance range can further cover the receiving field of view more widely, making the imaging effect at a short-distance better. That is, in this case, especially for the short-distance imaging, the field of view of the projection module 10 can be reduced compared to the conventional parallel arrangement of the optical axes, and the area of the light source 12 and the area of the mask 14 can be designed to be relatively small, which is conducive to miniaturization and cost reduction of the imaging device 100.

It can be understood that, the center X of the light source 12 and the center Y of the mask 14 are offset from the optical axis A1 of the projection lens 16, and the optical axis A2 of the projection module 10 and the optical axis A3 of the receiving module 20 will intersect at a certain distance. In other words, the center X of the light source 12 and the center Y of the mask 14 are not on the optical axis A1 of the projection lens 16, and the optical axis A2 of the projection module 10 and the optical axis A3 of the receiving module 20 form an angle with a certain angle degree. In this case, the center of the image projected by the projection module 10 is closer to the optical axis of the receiving module 20, the range of the projected image received by the receiving module 20 is the largest, and the image quality thereof is better. Therefore, in the present disclosure, it is not necessary to design the field of view of the projection module 10 to be larger, so that the area of the light source 12 and the area of the mask 14 can be designed to be smaller to obtain a miniaturized imaging device 100. Preferably, the center X of the light source 12 and the center Y of the mask 14 are offset in a direction away from the receiving module 20.

It should be noted that the first center X refers to the center of the light source 12, and the second center Y refers to the center of the mask 14. For example, when a planar shape of the light source 12 is a circle, the first center X is the center of the circle. For another example, when a planar shape of the mask 14 is a square, the second center Y is the intersection of two diagonals of the square.

In some embodiments, the first center X is offset from the optical axis A1 of the projection lens 16 by a distance in a range of 0.110 mm to 0.140 mm, for example, the offset distance may be 0.125 mm, and the second center Y is offset from the optical axis A1 of the projection lens 16 by a distance in a range of 0.110 mm to 0.140 mm. It should be noted that, the range of the above offset distance is a set of more preferred offset distance ranges obtained based on a condition that the current projection module 10 and the receiving module 20 are in relatively common matching sizes. Of course, the range of the offset distance can also be designed or adjusted based on the requirements for different intersection points, for example, if the intersection point needs to be close to the imaging device 100, it can be offset by a larger distance, and if the intersection point needs to be far away from the imaging device 100, it can be offset by a smaller distance, which is not limited in this embodiment.

In this way, the optical axis A2 of the projection module 10 and the optical axis A3 of the receiving module 20 intersect at a certain distance. It can be understood that the offset distance between the first center X and the optical axis A1 of the projection lens 16 and the offset distance between the second center Y and the optical axis A1 of the projection lens 16 are the same, and may be 0.110 mm, 0.125 mm, 0.140 mm, or any value between 0.110 mm to 0.140 mm. Preferably, the offset distance between the first center X and the optical axis A1 of the projection lens 16 and the offset distance between the second center Y and the optical axis A1 of the projection lens 16 are both 0.125 mm. The offset distance between the first center X and the optical axis A1 of the projection lens 16 and the offset distance between the second center Y and the optical axis A1 of the projection lens 16 can be determined by the field of view of the projection module 10 and the field of view of the receiving module 20, or be determined by the area of the light source 12.

In some embodiments, the projection module 10 includes a diffuser 18. The diffuser 18 is located between the light source 12 and the mask 14.

In this way, the diffuser 18 can diffuse the light beam emitted by the light source 12 and make the light beam distributed uniformly in the projection module 10. In other words, the light beam emitted by the light source 12 can form a uniform light beam through the diffusion by the diffuser 18. The uniform light beam refers to a light beam with a certain light distribution, density and uniformity.

Specifically, the diffuser 18 can be made by adding a scattering material to the material layer, or by making scattering properties on the surface layer, or by designing a diffractive microstructure on the surface, or by designing a Micro Lens Array (MLA) refractive microstructure on the surface. The diffuser 18 may be designed differently to meet the requirements of more scenes according to different uses and optical requirements, which is not limited in this embodiment.

In some embodiments, the diffuser 18 and the light source 12 are spaced apart, and the diffuser 18 and the mask 14 are spaced apart.

In this way, the diffuser 18 can be disposed as an independent element between the light source 12 and the mask 14, and can diffuse the light beam emitted by the light source 12 and make the light beam distributed uniformly in the projection module 10. In other words, a diffuser 18 can be added for the projection module 10 on the basis of the original elements, so that the diffuser 18 diffuses the light beam emitted by the light source 12 and make the light beam distributed uniformly in the projection module 10.

In other embodiments, the diffuser 18 is disposed on the mask 14. In other words, the diffuser 18 and the mask 14 are integrally provided, so that they can be designed as one element. The diffuser 18 is disposed on the mask 14, so that the spatial arrangement of the projection module 10 can be optimized without increasing the number of elements, which is beneficial to the assembling of the projection module 10. In some embodiments, for the projection module 10, the diffuser 18 and the mask 14 can be bonded through glue to form an integrated structure.

In some embodiments, the light source 12 is used to emit a light beam. The diffuser 18 is used to diffuse a light beam emitted by the light source 12 to form a uniform light beam. The mask 14 is used to project the uniform light beam emitted from the diffuser 18 to form a structured light beam. The projection lens 16 is used to project the structured light beam.

In this way, the light beam emitted by the light source 12 can be diffused by the diffuser 18 to form a uniform light beam, so that the structured light beam formed by the mask 14 has a better effect. The projection lens 16 can improve the effect of the projection of the structured light beam and achieve corresponding imaging quality, for example, a line width, a Depth of Focus (DOF), and a Field of View (FOV), and the like. It can be understood that the line width corresponds to a precision degree of the projection of the structured light beam, the depth of focus corresponds to an effective distance and a definition of the projection of the structured light beam, and the field of view corresponds to the range of the projection of the structured light beam. In an example, the structured light beam includes a coded structured light.

Further, the projection lens 16 includes at least one optical lens. In an example, the projection lens 16 may be one optical lens. In another example, the projection lens 16 may be a combination of multiple optical lenses.

In some embodiments, the mask 14 includes a light-transmitting region 142 and a light-shielding region 144. The light-transmitting region 142 is formed with a structured pattern, and the structured pattern is used to form a structured light beam.

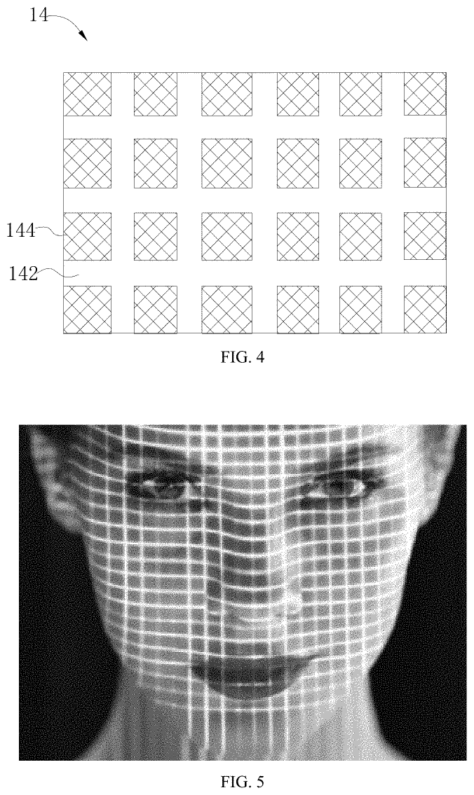

In this way, the light beam projected through the mask 14 can form a structured light beam corresponding to the structured pattern, that is, the mask 14 can project the light beam to form the structured light beam. It can be understood that the light beam cannot pass through the light-shielding region 144. For example, the light-shielding region 144 can shield or absorb the light beam. When the light beam is projected onto the mask 14, the light beam is blocked in the light-shielding region 144, and exits from the light-transmitting region 142 forming the structured pattern to form a structured light beam. The structured pattern includes, but is not limited to, a grid pattern, a dot pattern, or a line pattern. In an example of FIG. 4, the structured pattern is a grid pattern, and the structured light beam (projected image) is distributed in a grid shape (as shown in FIG. 5). In other embodiments, the structured pattern can also be other patterns, which are not specifically limited herein.

Specifically, the mask 14 can be made by mask 14 etching technology. For example, a layer of light-shielding material is covered on the light-transmitting material, and the light-shielding material in the light-transmitting region 142 is etched off by the mask 14 etching technology, while the light-shielding material in the light-shielding region 144 is retained.

In some embodiments, the light source 12 includes a vertical cavity surface emitting laser array. The vertical cavity surface emitting laser array includes a plurality of Vertical Cavity Surface Emitting Lasers (VCSELs) 122 distributed in an array.

In this way, using the vertical cavity surface emitting laser 122 array as the light source 12 can meet the requirement for the miniature size of the light source 12, and the array distribution formed by the plurality of vertical cavity surface emitting lasers 122 can ensure the continuity of the projection of the structured light beam. The vertical cavity surface emitting laser 122 is a small-size semiconductor laser, which can form an array distribution with a higher output power, and is used to create an efficient laser light source.

Referring to FIG. 3, in some embodiments, the projection module 10 includes an actuator 11. The actuator 11 is used to adjust the offset distance between the first center X and the optical axis A1 of the projection lens 16 and the offset distance between the second center Y and the optical axis A1 of the projection lens 16. The offset distance between the first center X and the optical axis A1 of the projection lens 16 and the offset distance between the second center Y and the optical axis A1 of the projection lens 16 are the same.

Further, the actuator 11 adjusts the offset distance based on the result of the imaging of the received light beam of the receiving module 20. For example, if the image received by the receiving module 20 is incomplete, the offset distance can be increased to make the intersection point between the optical axis A2 of the projection module 10 and the optical axis A3 of the receiving module 20 be close to the receiving module 20, thereby enlarging the projection coverage range corresponding to the field of view received at a close distance. If the image received by the receiving module 20 is not clear, the offset distance can be reduced so that the intersection point between the optical axis A2 of the projection module 10 and the optical axis A3 of the receiving module 20 is adjusted to the vicinity of the object to be measured, so as to achieve more clear imaging. The number of specific feedback adjustments and algorithms are not limited herein.

In this way, the actuator 11 can dynamically adjust the offset distance between the first center X and the optical axis A1 of the projection lens 16 and the offset distance between the second center Y and the optical axis A1 of the projection lens 16 so that the projected image received by the receiving module 20 has a better quality.

Referring to FIG. 3, the imaging device 100 according to the embodiments of the present disclosure includes a receiving module 20 and the projection module 10 of any of the above embodiments. The projection module 10 is used to project light beam to the object to be measured, and the receiving module 20 is used to receive and image the light beam projected by the projection module 10 and reflected by the object to be measured.

In the imaging device 100 of the embodiments of the present disclosure, the center X of the light source 12 and the center Y of the mask 14 of the projection module 10 are offset from the optical axis A1 of the projection lens 16, so that an optical axis A2 of the projection module 10 and an optical axis A3 of the receiving module 20 intersect at a certain distance (for example, 50 cm). At this time, the projected image (structured light beam) received at the intersection is the largest and the image quality thereof is better. In this case, the field of view of the projection module 10 can be reduced, and the area of the light source 12 and the area of the mask 14 can be designed to be relatively small, which is conducive to miniaturization and cost reduction of the imaging device 100.

It can be understood that the imaging device 100 according to the embodiments of the present disclosure is used to acquire three-dimensional contour information of an object. The imaging device 100 projects the structured light beam into a space through the projection module 10, and when the structured light beam is projected to an object in the space, a difference in the curvature or depth of the surface of the object will deform the projected image formed by the structured light beam. After the deformed projected image is captured by the receiving module 20, the 3D (three-dimensional) contour information of the object can be calculated through related algorithms.

In some embodiments, the receiving module 20 and the projection module 10 are arranged side by side. In this way, it is advantageous for the projection module 10 to project the structured light beam and the receiving module 20 to receive the light beam reflected by the object.

In some embodiments, the receiving module 20 includes an imaging lens 22 and an image sensor 24. The image sensor 24 is located on an image side of the imaging lens 22. The imaging lens 22 is used to converge the incident light to the image sensor 24.

In this way, the image sensor 24 can acquire a light beam reflected by the object, and the imaging lens 22 can converge the light beam to the image sensor 24, which is conducive for the receiving module 20 to receive the structured light beam reflected after being projected onto the object by the projection module 10.

Further, the imaging lens 22 includes at least one optical lens. In an example, the imaging lens 22 may be one optical lens. In another example, the imaging lens 22 may be a combination of a plurality of optical lenses.

In some embodiments, the receiving module 20 includes a filter 26 located between the imaging lens 22 and the image sensor 24.

In this way, the filter 26 can filter out other light beams other than the light beam projected by the projection module 10, avoiding interference of other light beams, so that the image information formed by the light beams acquired by the image sensor 24 is more accurate. In an example, the projection module 10 can project infrared rays, and the filter 26 can be an infrared filter. In this way, the infrared filter can filter out non-infrared light to prevent the non-infrared light from interfering with the image acquired by the image sensor 24.

Referring to FIG. 3, in some embodiments, the imaging device 100 further includes a processor 30 connected to the image sensor 24 and the actuator 11. The projection module 10 projects the structured light beam onto the object to be measured in the space, and the structured light beam reflected by the object to be measured is received by the image sensor 24 of the receiving module 20 to form an image, and then the image sensor 24 transmits the image to the processor 30. The processor 30 can analyze data such as the line width, uniformity, and distortion of the image to determine the imaging quality of the imaging device 100. When the image quality is poor, the processor 30 sends a driving signal to the actuator 11 to make the actuator 11 drive the light source 12 and the mask 14 to move, so that the offset distance between the first center X and the optical axis A1 of the projection lens 16 and the offset distance between the second center Y and the optical axis A1 of the projection lens 16 are maintained at optimal values, thereby improving the quality of the next-time imaging of the imaging device 100. At this time, the first center X and the second center Y are aligned along the axial direction of the projection module 10. Of course, when the projection module 10 includes the diffuser 18, the actuator 11 also drives the diffuser 18 to move so that the center of the diffuser 18 and the center of the light source 12 are aligned along the axial direction of the projection module 10.

It should be noted that the light source 12, the diffuser 18, the mask 14, and the projection lens 16 are all disposed in a lens barrel. The actuator 11 may be a Voice Coil Motor (VCM), and one voice coil motor may be disposed each between the light source 12 and an inner wall of the lens barrel, between the diffuser 18 and the inner wall of the lens barrel, and between the mask 14 and the inner wall of the lens barrel, and then by changing the magnitude of the direct current of the coils in the voice coil motors, the stretching positions of the spring sheets are controlled, so as to move the light source 12, the diffuser 18, and the mask 14. Of course, in other embodiments, the actuator 11 may be a Micro-Electro-Mechanical System (MEMS) actuator, a magnetostrictive actuator, or a piezoelectric actuator.

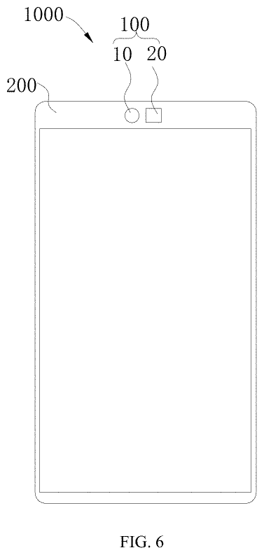

Referring to FIG. 6, the electronic device 1000 according to the embodiments of the present disclosure includes a housing 200 and the imaging device 100 of any of the above embodiments. The imaging device 100 is mounted in the housing 200.

In the electronic device 1000 of the embodiments of the present disclosure, the center X of the light source 12 and the center Y of the mask 14 of the projection module 10 are offset from the optical axis A1 of the projection lens 16, so that an optical axis A2 of the projection module 10 and an optical axis A3 of the receiving module 20 intersect at a certain distance (for example, 50 cm). At this time, the projected image (structured light beam) received at the intersection is the largest and the image quality thereof is better. In this case, the field of view of the projection module 10 can be reduced, and the area of the light source 12 and the area of the mask 14 can be designed to be relatively small, which is conducive to miniaturization and cost reduction of the imaging device 100.

It can be understood that the electronic device 1000 includes, but is not limited to, a electronic device such as a mobile phone, a tablet computer, a notebook computer, a smart wearable device, a door lock, a vehicle terminal, an unmanned aerial vehicle, and the like. In the example of FIG. 6, the electronic device 1000 is a mobile phone.

In the descriptions of this specification, the descriptions with reference to the terms “an embodiment”, “some embodiments”, “exemplary embodiment”, “example”, “specific example”, or “some examples”, or the like means that the specific features, structures, materials or characteristics described with reference to the embodiments or examples are included in at least one embodiment or example of the present disclosure. In this specification, the schematic representations of the above terms do not necessarily refer to a same embodiment or example. Moreover, the described specific features, structures, materials or characteristics can be combined in an appropriate manner in any one or more embodiments or examples.

Although the embodiments of the present disclosure have been shown and described, those of ordinary skill in the art can understand that various changes, modifications, substitutions, and modifications can be made to these embodiments without departing from the principle and purpose of the present disclosure. The scope of the present disclosure is defined by the claims and their equivalents.

What is claimed is:

1. A projection module, comprising:
a light source, comprising a first center;
a mask disposed above the light source, the mask comprising a second center, and the second center and the first center being aligned along an axial direction of the projection module; and
a projection lens disposed above the mask, and an optical axis of the projection lens being offset from the first center and the second center.

2. The projection module according to claim 1, wherein an offset distance between the first center and the optical axis of the projection lens ranges from 0.110 mm to 0.140 mm.

3. The projection module according to claim 1, wherein the projection module comprises a diffuser, and the diffuser is located between the light source and the mask.

4. The projection module according to claim 3, wherein the diffuser and the light source are spaced apart, and the diffuser and the mask are spaced apart.

5. The projection module according to claim 3, wherein the light source is configured to emit a light beam, the diffuser is configured to diffuse the light beam emitted by the light source to form a uniform light beam, and the mask is configured to project the uniform light beam emitted from the diffuser to form a structured light beam, and the projection lens is configured to project the structured light beam.

6. The projection module according to claim 5, wherein the mask comprises a light-transmitting region and a light-shielding region, the light-transmitting region is formed with a structured pattern, and the structured pattern is configured to form the structured light beam.

7. The projection module according to claim 1, wherein the light source comprises a vertical cavity surface emitting laser array, and the vertical cavity surface emitting laser array comprises a plurality of vertical cavity surface emitting lasers distributed in an array.

8. The projection module according to claim 1, wherein the projection module comprises an actuator, the actuator is configured to adjust an offset distance between the first center and the optical axis of the projection lens and an offset distance between the second center and the optical axis of the projection lens, and the offset distance between the first center and the optical axis of the projection lens is the same as the offset distance between the second center and the optical axis of the projection lens.

9. An imaging device, comprising:
a projection module, configured to project a light beam to an object to be measured; and
a receiving module, configured to receive and image the light beam reflected by the object to be measured and projected by the projection module;
the projection module comprising:
a light source, comprising a first center;
a mask disposed above the light source, the mask comprising a second center, and the second center and the first center being aligned along an axial direction of the projection module; and
a projection lens disposed above the mask, and an optical axis of the projection lens being offset from the first center and the second center.

10. The imaging device according to claim 9, wherein an offset distance between the first center and the optical axis of the projection lens ranges from 0.110 mm to 0.140 mm.

11. The imaging device according to claim 9, wherein the projection module comprises a diffuser, and the diffuser is located between the light source and the mask.

12. The imaging device according to claim 11, wherein the diffuser and the light source are spaced apart, and the diffuser and the mask are spaced apart.

13. The imaging device according to claim 11, wherein the light source is configured to emit a light beam, the diffuser is configured to diffuse the light beam emitted by the light source to form a uniform light beam, and the mask is configured to project the uniform light beam emitted from the diffuser to form a structured light beam, and the projection lens is configured to project the structured light beam.

14. The imaging device according to claim 13, wherein the mask comprises a light-transmitting region and a light-shielding region, the light-transmitting region is formed with a structured pattern, and the structured pattern is configured to form the structured light beam.

15. The imaging device according to claim 9, wherein the light source comprises a vertical cavity surface emitting laser array, and the vertical cavity surface emitting laser array comprises a plurality of vertical cavity surface emitting lasers distributed in an array.

16. The imaging device according to claim 9, wherein the projection module comprises an actuator, the actuator is configured to adjust an offset distance between the first center and the optical axis of the projection lens and an offset distance between the second center and the optical axis of the projection lens, and the offset distance between the first center and the optical axis of the projection lens is the same as the offset distance between the second center and the optical axis of the projection lens.

17. The imaging device according to claim 16, wherein the receiving module comprises an imaging lens and an image sensor, the image sensor is located on an image side of the imaging lens, and the imaging lens is configured to converge an incident light to the image sensor.

18. The imaging device according to claim 17, wherein the imaging device comprises a processor connected to the image sensor and the actuator, and the processor is configured to analyze a line width, uniformity, and a distortion of an image formed by the image sensor to determine an imaging quality of the imaging device.

19. The imaging device according to claim 9, wherein the receiving module and the projection module are arranged side by side.

20. An electronic device, comprising a housing and the imaging device of claim 9, the imaging device being mounted in the housing.
